(19) United States
(12) Patent Application Publication
(10) Pub. No.: US 2002/0168548 A1
(43) Pub. Date: Nov. 14, 2002

(54) Recording medium, method of manufacturing recording medium and recording-reproducing apparatus

(76) Inventors: Masatoshi Sakurai, Tokyo (JP); Hiroyuki Hieda, Yokohama-shi (JP); Katsuyuki Naito, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/138,572

(22) Filed: May 6, 2002

(30) Foreign Application Priority Data
May 9, 2001 (JP) 2001-138678

(51) Int. Cl. G11B 5/82

(52) U.S. Cl. 428/694 BR

(57) ABSTRACT

A recording medium has a substrate and a recording layer having isolation regions including crossed linear regions and substantially polygonal sections defined by the crossed linear regions, each of the sections containing particles of a recording material arrayed in a regular lattice. The linear regions of the isolation regions are formed along lowest-indexed planes of the regular lattice formed by the particles of the recording material.

### CROSS-REFERENCE TO RELATED APPLICATIONS

This application is based upon and claims the benefit of priority from the prior Japanese Patent Application No. 2001-138678, filed May 9, 2001, the entire contents of which are incorporated herein by reference.

### BACKGROUND OF THE INVENTION

1. Field of the Invention

The present invention relates to a recording medium a method of manufacturing a recording medium and a recording-reproducing apparatus.

2. Description of the Related Art

The amount of information is being markedly increased in the latest information-oriented society. Therefore, there are demands for an information recording-reproducing method and a recording-reproducing apparatus and a recording medium with drastically improved recording density based on the particular method. In order to improve the recording density, it is necessary to miniaturize the size of a recording cell or a recording mark, which constitutes the minimum unit of recording on the recording medium. However, the miniaturization of the recording cell or the recording mark faces a serious difficulty in the conventional recording medium.

For example, in a magnetic recording medium for a hard disk, a polycrystalline material having wide grain size distribution is used for forming the recording layer. However, the recording is rendered unstable in a recording layer formed of small polycrystalline particles because of thermal fluctuation of the crystals. Therefore, if the recording cell is small, the recording is rendered unstable and noise generation is increased, though a problem is not generated in the case where the recording cell is large. The unstable recording and the increased noise generation are brought about because, if the recording cell is small, the number of crystals contained in the recording cell is rendered small and interaction among the recording cells is rendered relatively large.

This is also the case with an optical recording medium using a phase-change material. Specifically, the recording is rendered unstable and the medium noise is increased in a recording density not lower than several hundred gigabits per square inch, in which the recording mark size is substantially equal to the crystal size of the phase-change material.

In order to avoid the difficulties pointed out above, proposed in the field of magnetic recording is a patterned media, in which a recording material is divided in advance by a non-recording material so as to carry out recording-reproducing by using a single particle of the recording material as a single recording cell, as disclosed in, for example, “S. Y. Chou et al., J. Appl. Phys., 76 (1994) pp 6673”; “U.S. Pat. No. 5,820,768”; “U.S. Pat. No. 5,956,216”; “R. H. M. New et al., J. Vac. Sci. Technol., B12 (1994) pp 3196”; and “Japanese Patent Application Laid-open Publication No. 10-233015”.

However, lithography technology is used in the conventional method of forming the structure in which the recording material particles are isolated. It is certainly possible for optical lithography to cope with the requirement for a high recording density in terms of throughput because a single step exposure is employed in optical lithography. However, it is hard in optical lithography to process recording cells sufficiently small in size. Electron beam lithography or a focused ion beam permit fine processing of about 10 nm. However, it is difficult to put these techniques to the practical use in view of the processing cost and the processing speed.

Japanese Patent Application Laid-open Publication No. 10-320772 discloses a method of manufacturing a magnetic recording medium having isolated magnetic fine particles formed on a substrate by lithography technology using a mask of fine particles having a size of several nanometers to several micrometers, which are two-dimensionally arrayed on the substrate. The method provides a cheap manufacturing method of a patterned media.

A method of arraying fine particles two-dimensionally on a substrate is proposed in, for example, “S. Hung et al., Jpn. J. Appl. Phys., 38 (1999) pp. L473-L476”. It is proposed that a substrate is coated with fine particles covered with long-chain alkyl groups so as to permit a hexagonal lattice pattern to be formed on a plane by utilizing autoagglutination of the fine particles during drying, thereby forming a relatively uniform single particle layer covering a large area.

Also known is a method of forming a structure having a pattern of circles arrayed to form a hexagonal lattice or a regularly striped pattern on a substrate by utilizing a self-ordering phase separation structure formed by a block copolymer, as reported in, for example, “M. Park et al., Science 276 (1997) 1401”. It is reported that, in a block copolymer such as polystyrene-block-polybutadiene or polystyrene-block-polyisoprene, it is possible to leave the polystyrene block alone by ozone treatment, and to form a structure such as holes or lines-and-spaces on the substrate by using the remaining polystyrene block as an etching mask.

In the above methods in which self-ordering particles such as fine particles or a block copolymer are two-dimensionally arrayed on a substrate, it is possible to obtain a structure in which the self-ordering particles are arrayed to form a lattice in a microscopic view. However, where a self-ordering pattern is formed on a smooth flat surface, hexagonal lattice domains with a limited size having crystal axes in random directions are generated at random positions. As a result, formed is a pattern of a polycrystalline structure in which the directions of the crystal axes are irregular as a whole so as to permit a large number of defects and grain boundaries to be present in a macroscopic view. In a patterned media including a polycrystalline pattern having crystal axes oriented random directions, the array directions and positions of the recording bits are made irregular, so that it is difficult that the write/read head access correctly each recording bit and sequentially read out the recording bits, resulting in failure to achieve practical recording-reproducing operation.

It follows that, where a patterned media is prepared by employing a self-ordering pattern formation, it is necessary to take measures for aligning the array directions of the pattern. For example, a method of aligning the pattern of the block copolymer in the direction of the linear step present on the surface of the single crystal is disclosed in “M. J. Fasolka et al., Phys. Rev. Lett., Vol. 79 (1997) p.3018.” In order to align the array directions of the self-ordering pattern on a patterned media, it is considered effective to employ the method of forming a guide pattern having directivity such as a linear groove structure or a ridge structure on the surface of the substrate. If self-ordering pattern is formed in the vicinity of the guide pattern, the formed pattern is arrayed along the groove or the land of the guide pattern. It follows that, if a concentric pattern of grooves or ridges are formed in the circumferential direction of the disk, i.e., in the track direction, it is considered possible to align the pattern directions of the recording material.

Where a patterned media is prepared by using the aforementioned concentric guide pattern, domains grow from random positions on the circumference of the disk substrate. In this case, a regular lattice structure is certainly formed within each domain. However, the individual domains do not match each other in the alignment of the lattices. It follows that, in the region where the adjacent domains grow to meet each other, the positional deviation in the lattice points takes place so as to generate defects in the alignment of the lattices. What should be noted is that, in a patterned media utilizing a self-ordering array, the random defects thus generated cause errors in writing to and readout from the recording medium.

It should also be noted that the track density is increased with increase in the recording density so as to make it very difficult to write servo marks for tracking. A method of achieving a high track density is proposed in, for example, Japanese Patent Application Laid-open Publication No. 6-111502. It is proposed that a servo pattern for tracking be formed in advance in the disk as a physical corrugated pattern. In this method, formed is a track close to a true circle, making it possible to increase the track density, compared with a conventional HDD. However, when it comes to a high recording density such as 100 Gbits to 1 Tbits per square inch, it is difficult to form the servo pattern by inexpensive optical lithography.

### BRIEF SUMMARY OF THE INVENTION

An object of the present invention is to provide a recording medium manufactured by utilizing self-ordering, in which the particles of the recording material are arrayed to form a regular lattice and so as to eliminate irregularity of the array and defect generation, to provide a method of manufacturing the particular recording medium, and to provide a recording-reproducing apparatus comprising the particular recording medium.

According to an aspect of the present invention, there is provided a recording medium, comprising: a substrate; and a recording layer formed on the substrate, and comprising isolation regions including crossed linear regions and substantially polygonal sections defined by the crossed linear regions, each of the sections containing particles of a recording material arrayed in a regular lattice, wherein the linear regions of the isolation regions are formed along the lowest-indexed planes of the regular lattice formed by the particles of the recording material.

According to another aspect of the present invention, there is provided a method of manufacturing a recording medium, comprising: forming, on a substrate, a pattern of isolation regions including crossed linear regions that define substantially polygonal sections; self-ordering a self-ordering material within each of the sections to form a structure in which particles of the self-ordering material are arrayed in a regular lattice; and forming a structure in which particles of a recording material are arrayed in a regular lattice corresponding to the regular lattice formed by the particles of the self-ordering material.

According to still another aspect of the present invention, there is provided a recording-reproducing apparatus, comprising the recording medium, a recording head, and a reproducing head.

### BRIEF DESCRIPTION OF THE SEVERAL VIEWS OF THE DRAWING

FIG. 1 is a plan view showing particles of a recording material arrayed into a hexagonal lattice within a single parallelogram section according to an embodiment of the present invention;

FIG. 2A is a plan view showing sections formed on the surface of a disk according to an embodiment of the present invention, and FIG. 2B is a magnified view of the sections shown in FIG. 2A.

FIG. 3 is a plan view showing particles of a recording material arrayed into a hexagonal lattice within a plurality of parallelogram sections according to an embodiment of the present invention;

FIG. 4 is a plan view showing particles of a recording material arrayed into a hexagonal lattice within a plurality of parallelogram sections according to an embodiment of the present invention;

FIG. 5 is a plan view showing particles of a recording material arrayed into a hexagonal lattice within a plurality of honeycomb sections according to an embodiment of the present invention;

FIG. 6 is a plan view showing particles of recording material arrayed into a tetragonal lattice within a plurality of grid sections according to an embodiment of the present invention;

FIGS. 7A to 7E are cross-sectional views showing a method of manufacturing a magnetic disk for Example 1 of the present invention;

FIG. 8 is a plan view showing a servo region formed in a magnetic disk for Example 2 of the present invention;

FIG. 9 is a cross-sectional view showing a magnetic disk and a head slider according to an embodiment of the present invention; and

FIG. 10 is a perspective view showing the internal construction of a magnetic disk apparatus according to an embodiment of the present invention.

### DETAILED DESCRIPTION OF THE INVENTION

Embodiments of the present invention will now be described in detail.

The entire shape of the recording medium according to the embodiments of the present invention is not particularly limited. For example, the shape of the recording medium may be a disk or a card. The disk-like recording medium comprises a disk substrate and a recording layer containing a recording material formed thereon. The disk is rotated and information is recorded in and read from the disk by using a head moving in a horizontal direction relative to the disk along the surface of the disk.

The recording material contained in the recording layer and the recording method using the particular recording material are not particularly limited. To be more specific, it is possible to use a magnetic recording material in the case of a recording-reproducing apparatus for reproducing magnetic information, to use a phase-change optical recording material or an magneto-optical recording material in the case of a recording-reproducing apparatus for optically reproducing information, or to use a conductor or a semiconductor in the case of a recording-reproducing apparatus for detecting an electric charge. It is also possible to use a photochromic material and a material having a physically irregular surface such as an array of pits or projections. The recording methods include, for example, methods utilizing magnetic field application, light irradiation, heating and pressurizing. Also, for reading information, utilized is change in the magnetic field in the recording layer, change in the degree of light scattering, change in color or change in the intensity of light reflected from the irregular surface.

Substantially polygonal sections defined by isolation regions including crossed linear regions are formed in the recording layer formed on the substrate, and the particles of the recording material are arrayed into a regular lattice within each section.

The term “section” represents a region in which particles of the recording material are arrayed for recording information on and reading the recorded information from the recording material particles. In general, the sections are formed along a track direction and divided within the track so as to be shaped substantially as a quadrilateral. The isolation regions defining the sections are generally formed of a non-recording material, though it is possible for the isolation regions to be formed of a recording material. In the case of a disk-like recording medium, the track is macroscopically formed concentric with the disk in the circumferential direction of the disk, and the section can be microscopically regarded as being surrounded by straight lines.

In each section, the particles of the recording material are arrayed to form a regular lattice. Each particle of the recording material has a certain size. If information is written in the recording material particle by a recording head, the state thereof is changed. In this case, it is possible to use an individual recording material particle as a single recording bit or to use a plurality of recording material particles as a single recording bit. The recording density is increased with increase in the number density of the recording material particles per unit area on the surface of the recording medium. If the bit density is increased, the distance between the adjacent recording bits on the surface of the recording medium is shortened, with the result that, when the recorded information is read, the read information of the adjacent recording bit is superposed on the read information of the target recording bit so as to bring about a crosstalk problem. It is possible to suppress the crosstalk problem by arranging a matrix region made of a non-recording material between the adjacent recording bits on the surface of the recording medium so as to divide the recording bits from each other. The “non-recording material” represents a material in which change in the state is not brought about by the writing operation unlike the recording material and which does not affect the information from the recording material in reading operation. It is possible to use, for example, SiO₂ or Al₂O₃ as the non-recording material, though the non-recording material is not limited to SiO₂ and Al₂O₃.

In such a manner, the particles of recording material are generally dispersed in a matrix formed of a non-recording material in which the particles of recording material are made columnar in the thickness direction of the recording layer and are made into an island-like particulate structure on the surface of the recording layer.

The recording material particles are arrayed to form a regular lattice (plane lattice) on the surface of the medium. The term “regular lattice” represents an array in which the coordinates representing the positions of the individual particles of the recording material are arranged at a predetermined distance apart from each other in a two-dimensional direction. The coordinates of the regular lattice arranged in a two-dimensional direction are represented by the sum of the integer times the fundamental vectors extending in different directions. The “fundamental vectors” represent, in the tetragonal lattice, the two vectors of the same magnitude, which cross each other at right angles, and, in the hexagonal lattice, the vectors of the same magnitude, which cross each other at an angle of 60° or 120°. The lattice position is represented by the sum of the integer times the two vectors, which integer is called an index.

The “lowest-indexed planes” denotes the direction represented by the single fundamental vector alone. The particles of the recording material are arrayed in these directions at a highest density.

For example, the lowest-indexed planes represent, in the tetragonal lattice, the directions of the two straight lines joining the nearest-neighbor lattice points and crossing each other at right angles, and, in the hexagonal lattice, the directions of the three straight lines joining the nearest-neighbor lattice points and crossing each other at an angle of 60° or 120°. In the recording medium according to the embodiments of the present invention, the isolation regions are formed along the direction of the lowest-indexed planes of the regular lattice formed by the particles of the recording material so as to permit the particles of the recording material to be arranged to form a regular array.

For manufacturing the recording medium of the particular construction, used is a method comprising: forming, on a substrate, a pattern of isolation regions including crossed linear regions that define substantially polygonal sections; self-ordering a self-ordering material within each section to form a structure in which particles of the self-ordering material are arrayed into a regular lattice; and forming a structure in which particles of a recording material arrayed into a regular lattice corresponding to the regular lattice formed by the particles of the self-ordering material.

The “self-ordering” represents the phenomenon that a material such as a block copolymer or particles or micelles or bubbles spontaneously forms a pattern without relying on artificial pattern formation when phase separation or aggregation takes place. It is possible to form a pattern of a very small size rapidly and with a low cost by utilizing the self-ordering pattern formation, though it was difficult to form such a pattern of a very small size by photolithography technology.

In the self-ordering, it is advantageous that circular particles are arrayed in a close-packed manner in order to form a pattern with low defects. In this case, the lattice formed by the self-ordering pattern formation is a hexagonal lattice. The hexagonal lattice includes circular particles arranged at a high density in a first direction and another circular particles arranged at a high density in a second direction crossing the first direction at an angle of 60°.

However, it is required to prevent a plurality of domains from being formed at random positions during the pattern formation so as not to cause defects at boundaries between adjacent domains. In the embodiments of the present invention, sections each having a prescribed area are partitioned in advance, and the pattern formation is allowed to take place within each section.

It is desirable for the area of the section to be smaller than the average domain size obtained by the random pattern formation on a flat surface of the substrate. In this case, only one domain is present inside the section in forming the pattern so as to form a single crystal structure within the section. Also, it is desirable for the section to have an outer shape in which the lattice structure obtained by the self-ordering pattern formation can be present stably. The most stable structure of the domain of the self-ordering array is the structure surrounded by the axes in which lattice points are arranged at the highest density within the array, i.e., surrounded by the lowest-indexed planes. Where the array forms a hexagonal lattice, the lowest-indexed planes include three axial directions of a first axial direction and two additional axial directions each inclined from the first axial direction by 60°. The shapes surrounded by these axial directions include a hexagon in which each of the corners has an angle of 120°, a regular triangle in which each of the corners has an angle of 60°, and a parallelogram or a trapezoid having two corners each having an angle of 60° and the additional two corners each having an angle of 120°. On the other hand, where the array forms a tetragonal lattice, the lowest-indexed planes include two axial directions of a first axial direction and a second axial direction inclined from the first axial direction by 90°. The shapes surrounded by these axial directions are, for example, a rectangle and a square.

FIG. 1 schematically shows as an example a parallelogram section 2 surrounded by two first parallel straight lines and two second parallel straight lines crossing with the first parallel straight lines at angles of 60° and 120° and particles 4 of the recording material arrayed within the section 2 in a self-ordered fashion so as to form a hexagonal lattice. The particles 4 of the recording material arrayed are arrayed along the directions of a-axis, b-axis and c-axis, i.e., lowest-indexed planes.

Where the section is shaped, for example, as a rectangle such that each of the four corners has an angle of 90°, in spite of the construction that the self-ordered pattern forms a hexagonal lattice, the domains aligned along the long side of the rectangle differ from the domains aligned along the short side of the rectangle in the axial direction so as to give rise to a polycrystalline structure having different axial directions. On the other hand, when it comes to a parallelogram section having two corners each having an angle of 60° and two additional corners each having an angle of 120°, the hexagonal lattice growing along any side of the parallelogram forms an array having the same axial direction, with the result that a polycrystalline structure having different axial directions is not generated. In other words, it is desirable for the section for forming the self-ordering pattern to have an outer shape formed of line segments parallel to the lowest-indexed planes obtained from the array of the self-ordering pattern. It follows that the structure formed by covering a substrate with parallelogram sections having two corners each having an angle of 60° and additional two corners each having an angle of 120° makes it possible to pack the self-ordering particles forming a hexagonal lattice at a high density and, thus, the particular structure is adapted for the patterned media. Also, the produced effect is not lost even if the angles of the four corners of the parallelogram are deviated by about ±10° from 60° or 120°. However, it is desirable for the deviation to be as small as possible.

The four corners of the parallelogram need not have acute angles, and it is possible for the four corner portions to be curved to have a curvature radius not larger than lattice spacing of the array of the recording bits.

Where the patterned media is in the shape of a disk, it is desirable for the parallelograms to be arrayed on the circumference of a circle. In this case, the linear regions in a track direction form a part of the circumference of a circle and, thus, are curved in a strict sense. However, the linear regions noted above can be regarded as forming a straight line in a microscopic view, as pointed out previously. In this case, the angle of each of the four corners of the parallelogram section represents in a strict sense the angle made between the linear region crossing a track and the direction of a line tangent to the circumference of a circle near the cross point thereof.

It should be noted that, if a linear region crossing the linear region in the track direction so as to intersect the track is allowed to cross a plurality of tracks, it is possible to partition a large number of sections with a smaller number of linear regions. Therefore, this method makes it possible to form easily a plurality of sections arranged in a large area compared with a method in which linear regions partitioning each section within a track are formed for every section. However, in the disk shape, the length of the circumference of the track differs depending on the radius and, thus, it is difficult to form linear regions extending from the track forming the outermost circumference to the track forming the innermost circumference. Such being the situation, it is desirable to form linear regions crossing the track for every group of tracks having a radius falling within a prescribed range, i.e., for every thin doughnut-like zone.

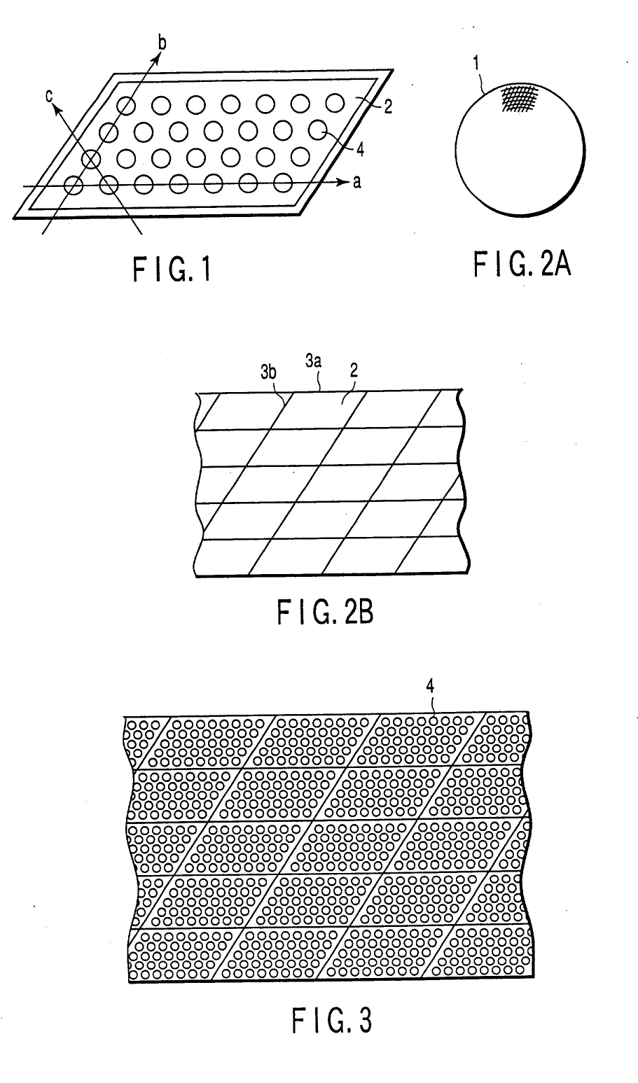

FIGS. 2A shows as an example sections formed on the surface of a disk 1 of a patterned media. On the other hand, FIG. 2B is a magnified view of the sections shown in FIG. 2A. The section 2 shown in FIG. 2B is defined by a lattice formed of a plurality of parallel linear pattern 3a forming a part of the concentric circles or a spiral parallel to tracks and a plurality of parallel linear pattern 3b crossing a part of the concentric circles or the spiral with an angle of 60° (or 120°).

FIG. 3 shows the particles 4 of the recording material that are regularly arrayed within the section 2. As shown in FIG. 3, the particles 4 of the recording material are regularly arrayed in the highest density by the self-ordering in each of the lattice-patterned sections 2 shown in FIG. 2B so as to form a single crystalline domain.

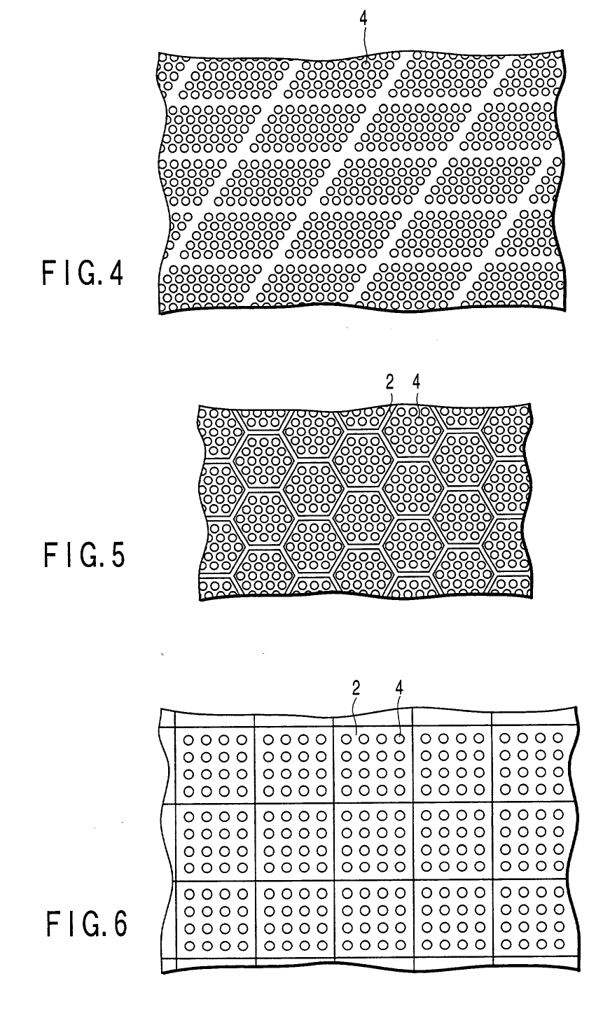

FIG. 4 shows the state that the positions alone of the recording material particles 4 are taken out of the structure shown in FIG. 3. As apparent from FIG. 4, all the particles 4 of the recording material are regularly arrayed so as to eliminate defects, making it possible to realize a patterned media capable of writing-reading information in and out of all the recording bits without error.

FIG. 5 shows the state that the particles 4 of the recording material are self-ordered to form a hexagonal lattice within each of the honeycomb-shaped sections 2. On the other hand, FIG. 6 shows the state that the particles 4 of the recording material are self-ordered to form a tetragonal lattice within each of the grid sections 2.

When recording-reproducing is performed with respect to the recording medium according to the embodiments of the present invention using a single particle for one bit, a write/read head covering a row of particles along the track direction or a write/read head covering two rows of particles along the track direction or a write/read head covering plural rows of particles along the track direction may be used. Also, recording-reproducing may be performed using two or more particles for one bit as described above.

The servo region included in the recording medium (patterned media) according to an embodiment of the present invention will now be described. The servo region matches with the array of the particles of the recording material. Therefore, in the case where the self-ordering pattern forms a hexagonal lattice, the servo region is formed in a parallelogram region surrounded by substantially parallel first linear regions extending in a track direction and second linear regions crossing the first linear regions substantially at an angle of 60° or 120°. In this case, the information read by the head during rotation of the disk is equal to that in the conventional disk-like recording medium, except that the shape of the servo region is changed to a parallelogram from a rectangular in the conventional disk-like recording medium. It follows that the conventional servo method and recording-reading method can be applied to the recording medium of the present invention.

An example of the manufacturing method of the recording medium according to an embodiment of the present invention will now be described in detail.

First, a recording layer of a recording material is formed on a disk substrate, followed by forming on the recording layer a control film for forming a pattern of a groove structure or a chemically treated band structure corresponding to a substantially polygonal section for controlling the array of the self-ordering particles. Then, a pattern of linear regions used as isolation regions is formed in the control film by lithography so as to form a groove structure or a band structure surrounded by the linear regions. After a film of the self-ordering material is formed within the groove structure or on the band structure, the self-ordering material is treated by, for example, annealing to form particles of the self-ordering material. A part of the film of the self-ordering material is etched and further the underlying recording layer is etched with the self-ordering particles used as a mask so as to form regularly arrayed particles of the recording material. After removal of the control film, the particles of the recording material are covered with a non-recording material forming a matrix, followed by polishing so as to obtain a recording medium. A protective layer may be formed on the recording layer as desired.

The chemically treated band structure can be formed by, for example, the following method. The method comprises: forming a recording layer, an SiO₂ film and a resist on a substrate, forming a resist pattern by lithography, treating to make the surface of the exposed SiO₂ film hydrophobic, and then removing the resist pattern so as to form on the surface of the SiO₂ film a hydrophobic band structure that forms substantially polygonal sections.

Any material can be used for the control film, as far as the material is capable of forming a structure by lithography without destroying the recording layer and does not incur damage by the formation of a film of the self-ordering particles and by the treatment for forming the regular array. For example, it is possible to use a resist for the control film. For the lithography of the control film, used is optical lithography, electron beam lithography, a method using a scanning probe such as an atomic force microscope, a scanning tunneling microscope or a near-field microscope, or nano imprint lithography (P. R. Krauss, et al., J. Vac. Sci. Technol., B13 (1995), pp. 2850).

The self-ordering particles used in the embodiments of the present invention include, for example, block copolymers, or fine particles having a size of scores of nanometers made of polymers and metals.

In the case of utilizing a block copolymer, it is desirable to use such a block copolymer comprising two or more blocks differing from each other in etching resistance in the processing means such as RIE or a block copolymer having a block that can be removed by some means. For example, in the case of using a polystyrene-block-polybutadiene copolymer, it is possible to apply development to permit the polystyrene block alone to be left unremoved by ozone treatment. Also, it is reported in “K. Asakawa et al., APS March Meeting, 2000” that, in the case of using a polystyrene-block-polymethyl methacrylate copolymer, it is possible to etch selectively the polymethyl methacrylate and the underlying recording layer by RIE (reactive ion etching) because polystyrene has higher etching resistance against RIE using CF₄ as an etchant than that of polymethyl methacrylate. In the case of using a block copolymer, it is desirable to use a molecule having a component ratio that permits forming a micellar structure or a cylinder structure on the surface of the substrate. In this case, it is possible to form regularly arrayed circular particles of the recording material that are divided from each other. It is necessary to select a block copolymer consisting of a combination of polymer blocks including a polymer block, which constitutes the micellar structure or the cylinder structure, having a high resistance to etching or including a polymer block constituting the micellar structure or the cylinder structure is left unremoved after development. It is possible to form a film of the block copolymer by spin coating using a solution prepared by dissolving the block copolymer in a suitable solvent such as toluene. It is possible to obtain phase separation of the block copolymer into the self-ordering array generally by annealing carried out under temperatures not lower than the glass transition temperature of the material.

In the case of using fine particles made of a polymer or a metal having a particle size of scores of nanometers, it is possible to form a self-ordering regular array by applying a solution having fine particles dispersed therein from above a disk having a band structure formed therein, followed by drying to remove the solvent, and then by removing the excessively adsorbed fine particles by using a suitable solvent. It is also possible to form a regular array by immersing a disk substrate in a solution having fine particles dispersed therein so as to permit the fine particles to be adsorbed on the disk substrate.

The particles of the recording material of a desired regular array can be prepared by etching the underlying recording layer by means of, for example, ion milling with the self-ordering particles used as a mask after formation of the regular array of the self-ordering particles by the method described above. In order to etch the recording layer in a high aspect ratio, it is also effective to form a film of SiO₂ or Si between the recording layer and the film of the self-ordering particles so as to transfer the regularly arrayed pattern of the self-ordering particles onto the SiO₂ or Si film by, for example, RIE, followed by processing the recording layer. Since it is possible to etch the film of SiO₂ or Si by RIE in a high aspect ratio, it is possible to etch the recording layer in a high aspect ratio by processing the recording layer with the film of SiO₂ or Si used as a mask. In this case, the pattern of the film of SiO₂ or Si is used as a control film for forming the isolation regions. It is possible to leave such a control film unremoved such that the manufactured recording medium includes the control film.

It is possible to manufacture a patterned media comprising the particles of the recording material buried in a matrix, if the regular array of the particles of the recording material thus prepared is covered with a material forming a matrix, followed by polishing the matrix for planarization.

Alternatively, it is possible to use a method of depositing a layer of a non-recording material used as a matrix on a substrate, forming a micropore array in the layer of the non-recording material, and filling the micropore array with a recording material as described below. First, a layer of a non-recording material used as a matrix and a control film are formed on a disk substrate. Then, a pattern of linear regions used as isolation regions is formed in the control film by lithography so as to form a groove structure or a band structure surrounded by the linear regions. After a film of the self-ordering material is formed within the groove structure or on the band structure, the self-ordering material is treated by, for example, annealing for self-ordering. The particles of the self-ordering material are etched and further the underlying layer of the non-recording material is etched with a part of the self-ordering material other that the particles used as a mask so as to form regularly arrayed micropore array. After removal of the control film, the micropore array formed in the layer of the non-recording material is filled with a recording material, followed by polishing so as to form a patterned media.

It is possible to prepare a stamp having a pattern of an irregular shape by a method using self-ordering particles and then the pattern of the stamp is transferred onto a disk substrate by nano imprint lithography as described below.

First, a control film for forming a groove structure or a chemically treated band structure for controlling an array of self-ordering particles is deposited on a disk stamp substrate, followed by forming a groove structure or a band structure in the control film by lithography. After formation of a film of the self-ordering material within the groove structure or on the band structure, the self-ordering particles are regularly arrayed by, for example, annealing. Further, etching is applied with the self-ordering particles used as a mask so as to prepare a stamp. Then, the control film is removed. On the other hand, a layer of a recording material or a layer of a non-recording material used as a matrix is formed a disk substrate, and further a resist used as a mask is formed thereon. The stamp, which is heated, is pressed against the resist so as to transfer the pattern of the stamp onto the resist. Further, the layer of the recording material of the layer of the non-recording material is etched so as to form an array of the recording material particles or a micropore array within the isolation region. Then, a recording medium is prepared by the methods described above.

### EXAMPLES

Some Examples of the present invention will now be described.

### Example 1

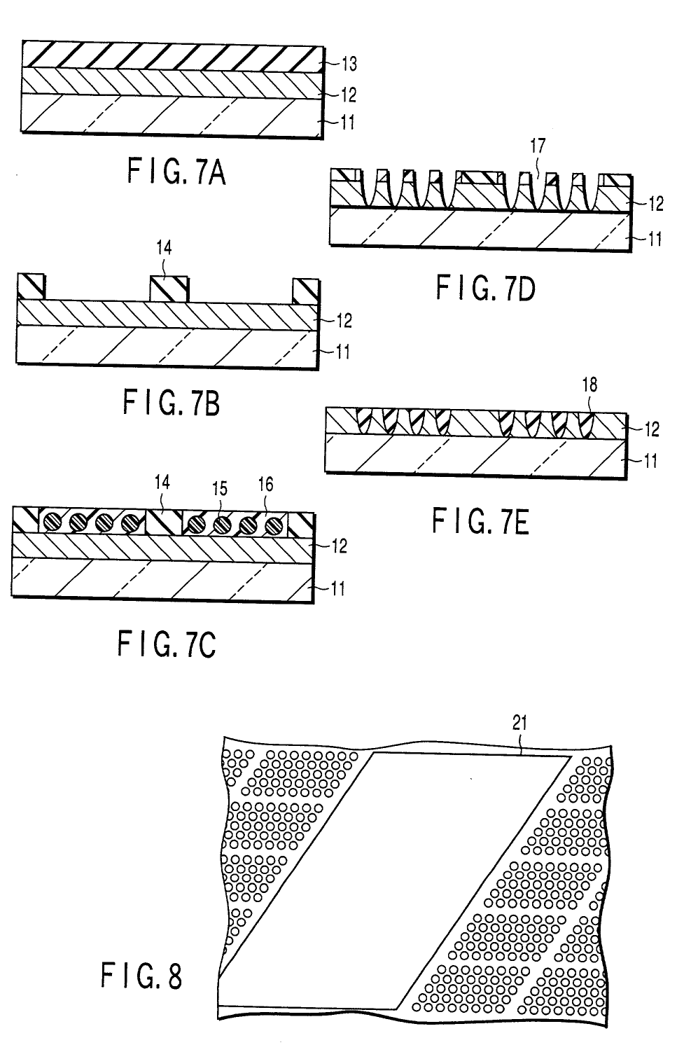

An example of manufacturing a magnetic disk according to a method of the present invention will be described referring to FIGS. 7A to 7E. FIGS. 7A to 7E are cross-sectional views of a disk cut along the radial direction.

As shown in FIG. 7A, a Co—Cr—Pt film 12 is formed as a perpendicular magnetic recording layer in a thickness of about 50 nm on a glass disk substrate 11, followed by forming a SiO₂ film 13 in a thickness of about 50 nm on the Co—Cr—Pt film 12.

Then, a resist film (not shown) is formed on the SiO₂ film 13 by spin-coating, followed by forming a resist pattern corresponding to isolation regions by photolithography, as shown in FIG. 7B. Further, the SiO₂ film 13 is selectively etched by RIE to reach the Co—Cr—Pt film 12 with the resist pattern used as a mask so as to form isolation regions 14 that define groove regions used as sections, followed by removing the resist pattern.

The isolation regions 14, whose cross sections are depicted in FIG. 7B, are projecting portions (first linear regions) corresponding to the linear regions 3a shown in FIG. 2B forming substantially concentric circles along the circumference (the track direction) of the disk, which are formed in a width of about 200 nm and a spacing of about 200 nm. Also formed simultaneously are projecting portions (second linear regions) corresponding to the linear regions 3b shown in FIG. 2B, not shown in FIG. 3B,crossing the above projecting portions extending along the circumference of the disk with an angle of 60° (or 120°). The pattern of the projecting portions crossing the pattern of the concentric projecting portions are formed for every doughnut-shaped region having a radius of a prescribed range by zoned constant angular velocity (ZCAV). The first linear regions and the second linear regions define groove regions used as sections having substantially parallelogram shape.

In the next step, hydrophobic treatment using hexamethyl disilazane is applied to the surface of the Co—Cr—Pt film 12, followed by forming a film of a polystyrene (PS)-block-polybutadiene (PB) copolymer (PS having a molecular weight of 10,000, and PB having a molecular weight of 40,000) by spin-coating using a solution prepared by dissolving the copolymer in toluene (1% w/w). Then, annealing is performed at 150° C. for 30 hours under vacuum so as to regularly array the block copolymer and, thus, to form island portions 15 made of polystyrene particles and a sea portion 16 made of polybutadiene, as shown in FIG. 7C.

Further, the block copolymer is treated with ozone, followed by washing with water so as to remove the self-ordering particles and subsequently etching the Co—Cr—Pt film 12 by means of Ar ion milling so as to form holes 17 with the remaining polystyrene used as a mask, as shown in FIG. 7D.

Finally, after the polystyrene is removed, an SiO₂ film 18 acting as a matrix is formed in a thickness of about 50 nm, followed by polishing the SiO₂ film 18 by chemical mechanical polishing (CMP), as shown in FIG. 7E. At this stage, a part of the Co—Cr—Pt film 12 positioned under the isolation regions 14 formed of SiO₂ is used as the isolation regions.

The magnetic disk thus manufactured is observed with a magnetic force microscope. It has been confirmed that the particles of the recording material forming a single domain are arrayed to form 6 rows of the close-packed structure in each parallelogram section having a width of 200 nm.

### Example 2

A servo region is formed in a part of the magnetic disk prepared in Example 1. Specifically, survo data are written in a substantially parallelogram servo region 21 by a servo writer in the magnetic disk prepared in Example 1, as shown in FIG. 8.

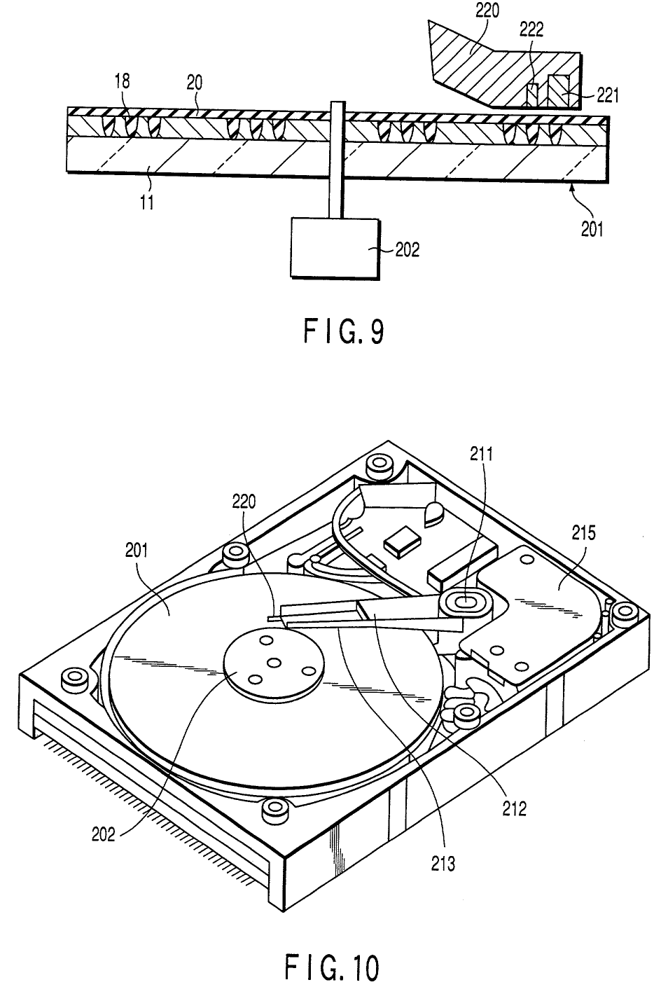

FIG. 9 is a cross-sectional view showing the magnetic disk and the head slider. The magnetic disk 201 is that prepared in Example 1, and comprises a glass substrate 11, a recording layer formed on the glass substrate 11, and a protective layer 20 formed on the entire surface. The recording layer comprises substantially parallelogram sections in which recording material particles 18 are arrayed regularly.

A read head 221 and a write head 222 are mounted on the tip of the head slider 220. A two-stage actuator (not shown) actuates the head slider 220 so as to control the positions thereof.

FIG. 10 is a perspective view showing the internal structure of a magnetic disk apparatus. As shown in the drawing, a magnetic disk 201 is mounted on a spindle motor 202 so as to be rotated in accordance with control signals supplied from a control section (not shown). An actuator arm 212 is supported on a shaft 211, and a suspension 213 and a head slider 220 at the tip of the suspension 213 are supported with the actuator arm 212. When the magnetic disk 210 is rotated, that surface of the head slider 220 which faces the recording medium is kept floating by a predetermined amount from the surface of the magnetic disk 201 so as to perform recording-reproducing of information. A voice coil motor 215 is mounted on the proximal end of the actuator arm 212 so as to allow the actuator arm 212 to rotate.

It is possible to obtain the servo data in reading the disk with the recording head by a method equal to that for the conventional magnetic disk having a substantially rectangle servo region defined by linear regions crossing the track direction with an angle of 90°.

### Example 3

This Example is directed to the method utilizing formation of a self-ordering structure by the anodic oxidation of an aluminum film. Specifically, a Co—Cr—Pt film as a perpendicular magnetic recording layer and an SiO₂ film are formed on a glass substrate as in Example 1, followed by forming by sputtering an aluminum film in a thickness of about 200 nm on the SiO₂ film. Then, a mold having hexagonal lattice-shaped projecting portions formed thereon 200 nm apart from each other is pressed against the surface of the aluminum film so as to form concave portions arrayed in a hexagonal lattice-shape on the surface of the aluminum film. Further, the substrate is subjected to anodic oxidation within a 10% aqueous solution of phosphoric acid, followed by polishing the surface of the substrate by means of CMP so as to obtain an aluminum oxide film having holes of a honeycomb structure in which hexagons are combined about the concave portions formed previously on the substrate. The block copolymer equal to that used in Example 1 is cast in the holes and a similar operation to that performed in Example 1 is performed so as to obtain a dot pattern in which a hexagonal lattice is incorporated in the holes of the honeycomb structure such that four particles are arrayed along one side of the hole. Further, a magnetic disk is manufactured using a similar method to that performed in Example 1.

### Example 4

Prepared was a magnetic disk in which the particles of the recording material are arrayed to form a tetragonal lattice. Specifically, a Co—Cr—Pt film and an SiO₂ film are formed on a glass substrate as in Example 1. Then, the SiO₂ film is coated with a resist film, followed by applying photolithography to the resist film so as to form a resist pattern of a grid structure in which projecting portions (linear regions) each having a width of 60 nm and arranged 400 nm apart from each other are allowed to cross additional projecting portions (linear regions) of the same construction at right angles. Then, the SiO₂ film is selectively etched by RIE with the resist pattern used as a mask so as to form isolation regions. Then, the selectively etched SiO₂ film is coated with iron-cobalt fine particles chemically modified with alkyl chains so as to obtain an array of iron-cobalt fine particles in which tetragonal lattices are incorporated in each section of the grid structure such that 20 particles are arranged along one side of each section. Information is written in the iron-cobalt fine particles by using a magnetic head so as to confirm the operation as a magnetic disk.

Additional advantages and modifications will readily occur to those skilled in the art. Therefore, the present invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A recording medium, comprising:
a substrate; and
a recording layer formed on the substrate, and comprising isolation regions including crossed linear regions and substantially polygonal sections defined by the crossed linear regions, each of the sections containing particles of a recording material arrayed in a regular lattice,
wherein the linear regions of the isolation regions are formed along the lowest-indexed planes of the regular lattice formed by the particles of the recording material.

2. The recording medium according to claim 1, wherein the isolation regions include first linear regions along directions of tracks and second linear regions across the tracks, and wherein each of the sections is substantially formed into a quadrilateral.

3. The recording medium according to claim 2, the second linear regions cross the first linear regions substantially at an angle of 60° or 120°, and wherein each of the sections is substantially formed into a parallelogram in which the particles of the magnetic material form a hexagonal lattice.

4. The recording medium according to claim 1, wherein the isolation region is formed of a non-recording material.

5. The recording medium according to claim 1, wherein the isolation region is formed of a recording material.

6. The recording medium according to claim 1, wherein the particles of recording material are dispersed in a matrix formed of a non-recording material, the particles of recording material being made columnar in the thickness direction of the recording layer and being made into a island-like particulate structure on the surface of the recording layer.

7. The recording medium according to claim 1, wherein the recording material is a magnetic recording material.

8. The recording medium according to claim 1, wherein the recording material is an optical recording material.

9. The recording medium according to claim 3, further comprising a servo region substantially made into parallelogram defined by the first linear regions and the second linear regions.

10. A method of manufacturing a recording medium, comprising:
forming, on a substrate, a pattern of isolation regions including crossed linear regions that define substantially polygonal sections;
self-ordering a self-ordering material within each of the sections to form a structure in which particles of the self-ordering material are arrayed in a regular lattice; and
forming a structure in which particles of a recording material are arrayed in a regular lattice corresponding to the regular lattice formed by the particles of the self-ordering material.

11. The method according to claim 10, wherein a pattern of the linear regions are formed to project from the substrate and the sections are defined by the pattern of the linear regions are formed on the substrate.

12. The method according to claim 10, wherein a pattern of the linear regions is hydrophilic or hydrophobic and the sections defined by the pattern of the linear regions are hydrophobic or hydrophobic, respectively.

13. The method according to claim 10, further comprising:
forming a layer of the recording material on the substrate; and
forming a structure in which particles of the recording material are arrayed in a regular lattice corresponding to the regular lattice formed by the particles of the self-ordering material; and
forming a matrix of a non-recording material that surrounds the particles of the recording material.

14. The method according to claim 10, further comprising:
forming a layer of a non-recording material on the substrate;
forming, in the layer of the non-recording material, a structure in which micro pores are arrayed in a regular lattice corresponding to the regular lattice formed by the particles of the self-ordering material; and
filling the micro pores with the recording material to form a structure in which particles of the recording material are arrayed in a regular lattice corresponding to the regular lattice formed by the micro pores.

15. A recording-reproducing apparatus, comprising:
the recording medium according to claim 1;
a recording head; and
a reproducing head,
the recording head and the reproducing head being disposed on the recording medium.

16. The recording medium according to claim 2, wherein the substrate has a disk shape, and wherein the tracks are concentric.

17. The recording medium according to claim 3, wherein the substrate has a disk shape, and wherein the tracks are concentric.
